(19) United States
(12) Patent Application Publication
(10) Pub. No.: US 2026/0246353 A1
(43) Pub. Date: Aug. 20, 2026

(54) LINEAR MOTOR, LINEAR MOTOR SYSTEM, AND OPTICAL APPARATUS

(71) Applicant: CANON KABUSHIKI KAISHA, Tokyo (JP)

(72) Inventor: KYOSUKE SATO, Kanagawa (JP)

(21) Appl. No.: 19/532,491

(22) Filed: Feb. 6, 2026

(30) Foreign Application Priority Data
Feb. 19, 2025 (JP) 2025-025119

(51) Int. Cl. H02K 41/03; G03B 5/00; G03B 17/14; H02K 1/34

(52) U.S. Cl. CPC H02K 41/031; G03B 5/00; G03B 17/14; H02K 1/34; G03B 2205/0069; H02K 2213/03

(57) ABSTRACT

In a linear motor, a first coil and a second coil are disposed so that a phase distance between each other's centroids in an axial direction becomes 90° + n × 180° (n is an integer), corresponding to a periodic change characteristic along the axial direction of an interlinkage magnetic flux density caused by a field magnet portion. A third coil is disposed at a position relative to either the first coil or the second coil such that a phase distance between each other's centroids in the axial direction is greater than 135° and smaller than 225°. A thrust as a resultant force is obtained by controlling an energization amount ratio between the first, the second, and the third coils according to a phase of an armature relative to the field magnet portion.

### BACKGROUND

### Field of the Technology

The present disclosure relates to a linear motor, a linear motor system, and an optical apparatus.

### Description of the Related Art

An electromagnetic linear direct current motor (hereinafter, referred to as “a linear motor”) has been widely used in a positioning mechanism for a precision instrument such as an optical apparatus. While the linear motor exhibits an excellent characteristic for positioning the precision instrument, the linear motor does not have any holding force when not energized, so there is an issue in that the linear motor must be constantly energized when in a posture where the linear motor needs to support the own weight of an object to be positioned. In particular, in the case where the linear motor exhibits a fluctuation in efficiency depending on a stroke position, that is, exhibits a thrust ripple, it is necessary to ensure the efficiency required for positioning even at a position where the efficiency is minimum, therefore there is an issue of becoming a bottleneck in practical use.

In order to address this issue, a technique disclosed in Japanese Laid-Open Patent Publication (kokai) No. 2021-175244 reduces some of maximum values in a thrust ripple to minimum values by making the shape of a field magnet portion of a linear motor to be a shape in which the cross-sectional shape in a coil interlinkage direction changes depending on a stroke position, thereby alleviating the bottleneck. In addition, a technique disclosed in PCT International Publication No. WO2021/153017 improves the overall efficiency by increasing the number of coils combined with a field magnet portion in a linear motor beyond the minimum required number.

However, in the configuration of Japanese Laid-Open Patent Publication (kokai) No. 2021-175244, the shape of the part (the component) of the linear motor becomes complex, while the effect of reducing the thrust ripple remains limited. In addition, in the technique disclosed in PCT International Publication No. WO2021/153017, there is an issue that by increasing the number of the coils combined with the field magnet portion, the overall length of the linear motor in a stroke direction will increase.

### SUMMARY

The present disclosure provides a linear motor capable of mitigate a bottleneck while suppressing increasing in size and complexity, a linear motor system, and an optical apparatus.

Accordingly, a first aspect of the present disclosure provides a linear motor comprising an armature configured to include coils, and a field magnet portion configured to include permanent magnets and yokes, the field magnet portion moving in an axial direction relative to the armature. In the field magnet portion, the permanent magnets and the yokes are disposed so that an interlinkage magnetic flux density, which is a density of interlinkage magnetic flux acting on the armature, changes periodically along the axial direction. The armature includes a first coil and a second coil, and the first coil and the second coil are disposed so that a phase distance between each other's centroids in the axial direction becomes 90° + n × 180° (n is an integer), corresponding to a periodic change characteristic along the axial direction of the interlinkage magnetic flux density caused by the field magnet portion. At least one third coil is further disposed on the armature in accordance with the periodic change characteristic along the axial direction of the interlinkage magnetic flux density caused by the field magnet portion. A thrust as a resultant force is obtained by controlling an energization amount ratio between the first coil, the second coil, and the third coil in accordance with a phase of the armature relative to the field magnet portion. The third coil is disposed at a position relative to either the first coil or the second coil such that a phase distance between each other's centroids in the axial direction is greater than 135° and smaller than 225°.

Accordingly, a second aspect of the present disclosure provides a linear motor system comprising the linear motor. In the linear motor, gain control for reducing the thrust at a phase where a maximum value of the thrust occurs is performed.

Accordingly, a third aspect of the present disclosure provides an optical apparatus comprising the linear motor, and an optical device configured to be driven by the linear motor and be positioned in an optical axis direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of a linear motor according to a first embodiment.

FIG. 2 includes a longitudinal section view of the linear motor according to the first embodiment and a diagram that illustrates an interlinkage magnetic flux density profile of the linear motor according to the first embodiment.

FIG. 3 is a diagram that illustrates a characteristic of a thrust due to energization control in the linear motor according to the first embodiment.

FIG. 4 is a diagram that illustrates a block diagram of a linear motor system together with a profile of a correction gain.

FIG. 5 is a schematic perspective view of a linear motor according to a second embodiment.

FIG. 6 includes a longitudinal section view of the linear motor according to the second embodiment and a diagram that illustrates an interlinkage magnetic flux density profile of the linear motor according to the second embodiment.

FIG. 7 is a diagram that illustrates a characteristic of a thrust due to energization control in the linear motor according to the second embodiment.

FIG. 8 is a perspective view of a camera system to which the linear motor is applied.

FIG. 9 is an exploded perspective view of an optical apparatus in the camera system.

FIG. 10 includes a longitudinal section view of a first comparative example (a conventional multi-pole linear motor 500) and a diagram that illustrates an interlinkage magnetic flux density profile of the first comparative example.

FIG. 11 is a diagram that illustrates a characteristic of a thrust due to energization control in the first comparative example.

FIG. 12 includes a longitudinal section view of a second comparative example (a linear motor 600 improved from the first comparative example) and a diagram that illustrates an interlinkage magnetic flux density profile of the second comparative example.

FIG. 13 is a diagram that illustrates a characteristic of a thrust due to energization control in the second comparative example.

FIG. 14 includes a longitudinal section view of a third comparative example (a conventional multi-pole linear motor 700) and a diagram that illustrates an interlinkage magnetic flux density profile of the third comparative example.

FIG. 15 is a diagram that illustrates a characteristic of a thrust due to energization control in the third comparative example.

### DESCRIPTION OF THE EMBODIMENTS

The present disclosure will now be described in detail below with reference to the accompanying drawings showing embodiments thereof.

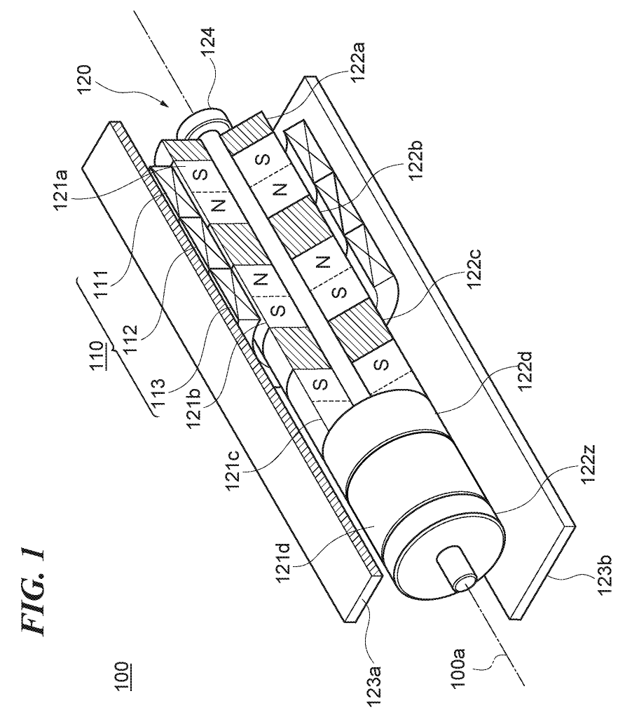

First, a first embodiment of the present disclosure will be described. It should be noted that in the present disclosure, “a phase” or “a phase distance” means an angle corresponding to a position in an axial direction (an axial line direction) of main shaft 100a, and the difference therebetween, when one period of an interlinkage magnetic flux density profile by a field magnet portion is 360°. In other words, the position is expressed as an angle based on a correspondence relationship between a distance in the axial direction of main shaft 100a and the period of the interlinkage magnetic flux density profile. FIG. 1 is a schematic perspective view of a linear motor according to the first embodiment of the present disclosure. FIG. 1 illustrates the main part of a linear motor 100. The linear motor 100 is configured by combining an armature 110 and a field magnet portion 120.

The linear motor 100 has a shape that is bilaterally symmetric or radially symmetric about a main shaft 100a, and generates a thrust in a substantially parallel direction on the main shaft 100a. In other words, due to the interaction between the armature 110 and the field magnet portion 120, the linear motor 100 generates a thrust in the axial direction of the main shaft 100a, thereby driving a load. The axial direction of the main shaft 100a is a linear drive direction in which the field magnet portion 120 moves relative to the armature 110.

The armature 110 of the linear motor 100 includes a first coil 111, a second coil 112, and a third coil 113. These coils (the first coil 111, the second coil 112, and the third coil 113) are, for example, air-core coils made by winding enameled wire, or bobbin wound coils. The field magnet portion 120 of the linear motor 100 includes permanent magnets 121a to 121d, inner yokes 122a to 122d and 122z, outer yokes 123a and 123b, and a skewer 124.

The permanent magnets 121a to 121d are, for example, neodymium magnets, and the permanent magnets 121a to 121d mainly play a role in generating magnetic flux in the field magnet portion 120 to form a magnetic field. A magnetization direction of the permanent magnets 121a to 121d is parallel to the axial direction of the main shaft 100a.

The inner yokes 121a to 121d and 122z and the outer yokes 123a and 123b are members generally called yokes, and are disposed adjacent to, interposed between or facing magnetic pole faces of the permanent magnets 121a to 121d, respectively. The inner yokes 122a to 122d and 122z and the outer yokes 123a and 123b play a role in concentrating the magnetic flux generated from magnetic poles of the permanent magnets 121a to 121d and forming a properly oriented magnetic field for generating a thrust against the armature 110. The inner yokes 122a to 122d and 122z and the outer yokes 123a and 123b are made of, for example, corrosion-resistant plated mild steel or corrosion-resistant coated mild steel.

The skewer 124 is a skewer-shaped member that plays a role in passing through, bundling and holding the permanent magnets 121a to 121d and the inner yokes 122a to 122d and 122z. The skewer 124 is made of a non-magnetic, high-strength material such as a non-ferrous metal, for example, a copper alloy. By bundling and holding the permanent magnets and the inner yokes together, the assembly labor required to fix these members, for example, by gluing them together, is reduced, and the increase in size and weight that will occur when they are fixed by using a separate fixing member is avoided. For this reason, the permanent magnets 121a to 121d and the inner yokes 122a to 122d and 122z are all ring-shaped with through holes. However, the present disclosure is not limited to this configuration, and a configuration may be adopted in which the permanent magnets and the inner yokes are fixed to each other by adhesive or the like, and have a solid shape without a through hole, or a rectangular external shape instead of a cylindrical external shape.

In the linear motor 100, when the coils 111 to 113 of the armature 110 under the magnetic field of the field magnet portion 120 are energized, a Lorentz force on electric charges is generated, which becomes a thrust for driving the load. In an apparatus to which the linear motor 100 is applied, a load to be driven is capable of being driven by connecting and fixing one of the armature 110 and the field magnet portion 120 to the load to be driven (a movable side), and connecting and fixing the other of the armature 110 and the field magnet portion 120 to a fixed side.

Generally, the principle of generating a Lorentz force in a linear motor and the techniques for increasing the efficiency of generating a thrust are publicly known, so detailed illustrations will be omitted here and only a brief description will be given.

In the linear motor 100, for example, attention will be focused on the coil 112. Inside the winding shape of the coil 112, which is disposed so that its winding axis is substantially aligned with the main shaft 100a, the permanent magnet 121a and the permanent magnet 121b, for example, are disposed so that their same north pole faces face each other in a main shaft 100a direction. Furthermore, the inner yoke 122b is disposed to be interposed between the permanent magnet 121a and the permanent magnet 121b, which generates interlinkage magnetic flux that spreads radially from the inside of the coil 112 to the outside of the coil 112. When the coil 112 is energized, a Lorentz force, which is approximately proportional to this interlinkage magnetic flux and the electric current, is generated.

In addition, the outer yokes 123a and 123b are disposed on the outside of the winding shape of the coil 112. The outer yokes 123a and 123b have a shape that extends in the main shaft 100a direction (the axial direction of the main shaft 100a), and face the permanent magnets and the inner yokes. As a result, for example, the magnetic flux generated by the permanent magnets 121a and 121b and the inner yoke 122b is concentrated, and the density of the interlinkage magnetic flux acting on the coil 112 is increased. In addition, the concentrated magnetic flux is guided to the permanent magnets 121b and 121c with their south pole faces facing each other at adjacent positions and the inner yoke 122c, thereby increasing the total amount of the magnetic flux released to the outside in the permanent magnet 121b against the internal anti-magnetic field.

When the armature 110 moves (strokes) relative to the field magnet portion 120 in the main shaft 100a direction and the coil 112 moves away from the permanent magnets 121a and 121b and the inner yoke 122b, the coil 111 or the coil 113 located before or after the coil 112 then moves closer to the permanent magnets 121a and 121b and the inner yoke 122b. Therefore, when these coils are energized in the same manner, a Lorentz force similar to that of the coil 112 before the stroke is generated. Alternatively, at the position where the coil 112 has stroked (at the destination of the stroke of the coil 112), a Lorentz force is capable of being generated by changing the energization in accordance with the magnetic field generated by the corresponding permanent magnets and the corresponding inner yokes. For example, at the position (the center position) of the inner yoke 122c in the main shaft 100a direction where the same south pole faces of the permanent magnets 121b and 121c face each other, interlinkage magnetic flux in the opposite direction to that before the stroke is applied to the coil 112. Therefore, by reversing the energization direction in which the coil 112 is energized, a Lorentz force in the same direction as before the stroke is capable of being generated.

Here, when this intermediate position, that is, the center position of the coil 112 in the main shaft 100a direction is stroked (moved) to a position near the center of the permanent magnet 121b, the magnitude of the interlinkage magnetic flux acting on the coil 112 becomes zero unlimitedly. For this reason, even if the coil 112 is energized, a Lorentz force is not capable of being obtained. However, in this state, by performing an arrangement so that a strong interlinkage magnetic flux is applied to other coils (the coil 111 or the coil 113) and energizing these other coils, the armature 110 as a whole is capable of obtaining a Lorentz force.

In such a configuration, the following arrangement is generally adopted.

First, in the field magnet portion 120, the permanent magnets and the yokes are disposed so that an interlinkage magnetic flux density, which is the density of the interlinkage magnetic flux acting on the armature 110, changes periodically along the main shaft 100a direction. A characteristic of the interlinkage magnetic flux density that changes periodically in the main shaft 100a direction formed by the field magnet portion 120 is referred to as the interlinkage magnetic flux density profile. Each coil is disposed so that a center-to-center distance in the main shaft 100a direction of at least a pair of coils among the coils 111 to 113 in the armature 110 (a phase distance between each other's centroids in the axial direction) becomes a distance close to 90° + n × 180° in a magnetic phase. As a result, it is possible to generate a thrust from the armature 110 with relatively stable efficiency at any continuous stroke position.

A linear motor with such a configuration is generally referred to as “a multi-pole (direct current) linear motor” or “a multi-phase (direct current) linear motor”, and is configured to obtain a thrust by performing energization control with respect to the pair of coils described above in accordance with the stroke position (the phase).

Here, before describing the effects of the multi-pole linear motor 100 according to the first embodiment, a conventional multi-pole linear motor will be described as a comparative example.

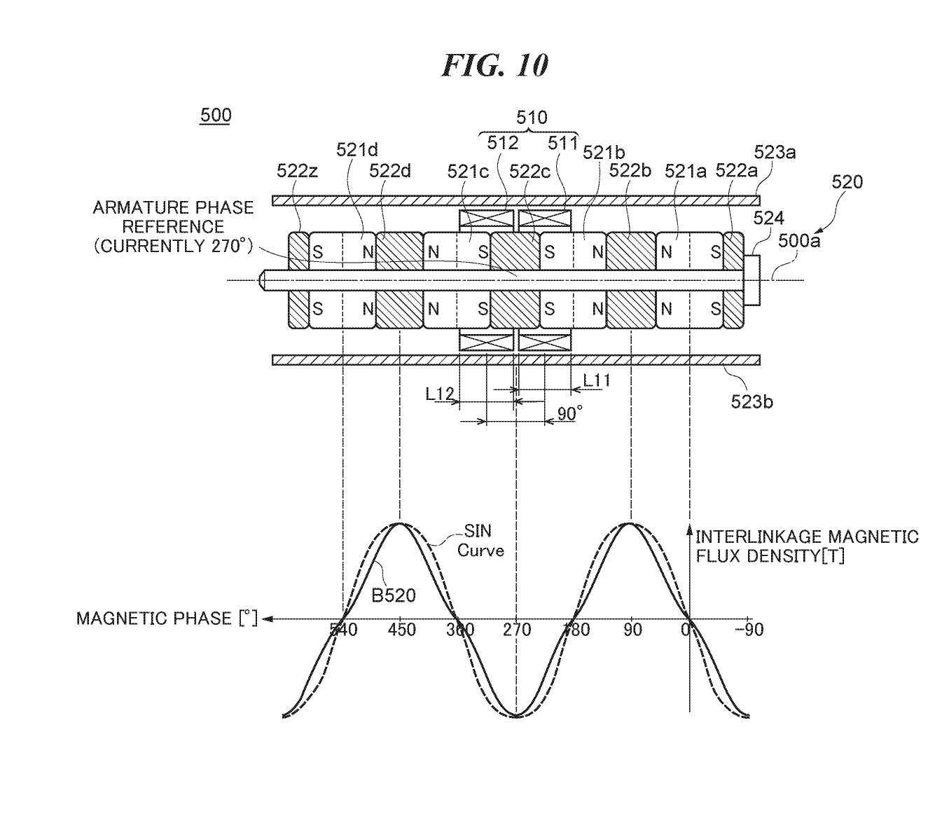

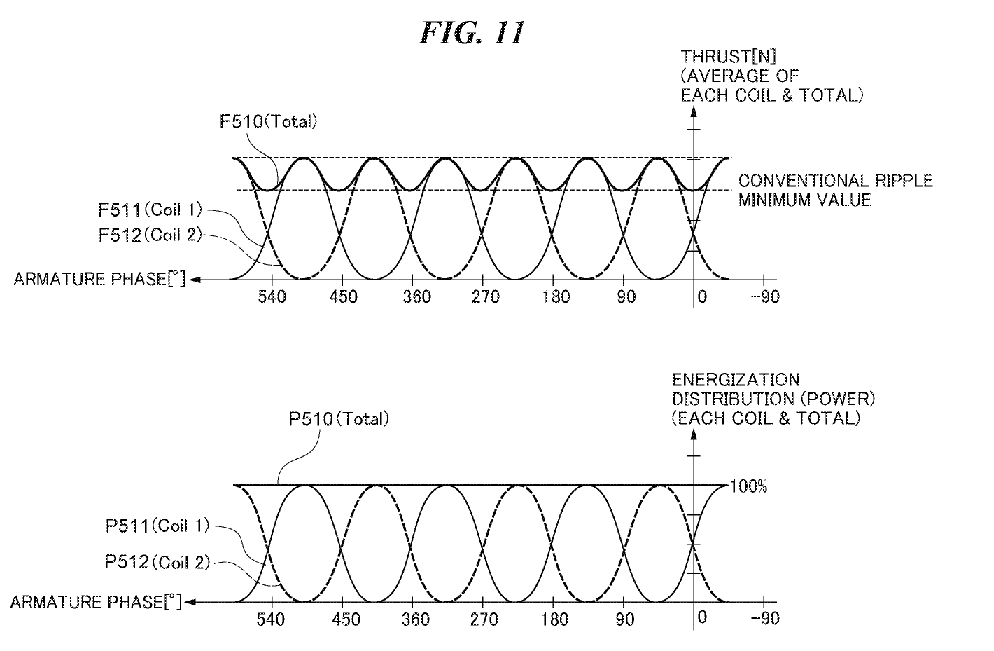

FIG. 10 includes a longitudinal section view of a first comparative example (a conventional multi-pole linear motor 500) and a diagram that illustrates an interlinkage magnetic flux density profile of the first comparative example. FIG. 11 is a diagram that illustrates a characteristic of a thrust due to energization control in the first comparative example.

The linear motor 500, which is a conventional example, has the same configuration as the linear motor 100 according to the first embodiment, except for the characteristic novel configuration of the linear motor 100 according to the first embodiment. Therefore, in the linear motor 500 of FIG. 10, parts (portions) corresponding to those of the linear motor 100 are given reference numerals with the same last two digits.

An armature 510 includes a first coil 511 and a second coil 512 that are similar to the first coil 111 and the second coil 112 of the armature 110, but does not includes the third coil 113. A field magnet portion 520 includes permanent magnets 521a to 521d and inner yokes 522a to 522d and 522z that are similar to the permanent magnets 121a to 121dand the inner yokes 122a to 122d and 122z of the field magnet portion 120. In addition, the field magnet portion 520 includes outer yokes 523a and 523b and a skewer 524 that are similar to the outer yokes 123a and 123b and the skewer 124 of the field magnet portion 120.

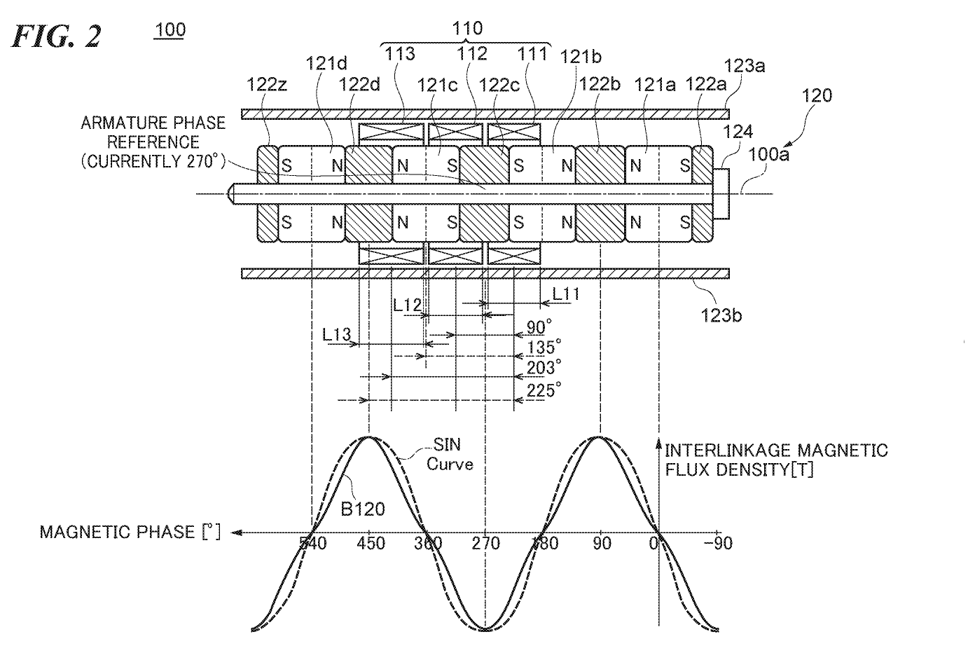

FIG. 10 shows an interlinkage magnetic flux density profile B520 formed by the field magnet portion 520 of the linear motor 500. It should be noted that since the field magnet portion 520 includes the same configuration as the field magnet portion 120, the interlinkage magnetic flux density profile B520 is the same as an interlinkage magnetic flux density profile B120 (see FIG. 2) of the linear motor 100 according to the first embodiment.

In the linear motor 500 exhibiting such an interlinkage magnetic flux density profile B520, the energization control with respect to the coils shown in FIG. 11 is performed in accordance with an armature phase corresponding to the stroke position of the armature 510 relative to the field magnet portion 520, thereby obtaining a thrust.

Under an assumption that a total value P510 of the energization amount (the power) corresponding to the input is approximately constant regardless of the armature phase, a thrust is obtained by summing the Lorentz forces of the first coil 511 and the second coil 512 of the armature 510. An energization amount P511 and an energization amount P512, which are applied to these coils, are distributed so as to maximize this total thrust.

For example, in a state shown in FIG. 10 where the armature phase is 270°, the central phase of the first coil 511 is about 225°, and the central phase of the second coil 512 is about 315°. In this state, the magnitudes of the interlinkage magnetic flux densities in these phases, which are capable of being read from the interlinkage magnetic flux density profile B520, are approximately equal.

Therefore, as shown in FIG. 11, in the state where the armature phase is 270°, by energizing the first coil 511 and the second coil 512 in approximately equal portions (about 50%), a thrust is capable of being obtained with maximum efficiency at this armature phase (270°). This is because, if the interlinkage magnetic flux densities of the two coils are approximately the same, it is more efficient to half-amount-energize each of the two coils than to full-amount-energize one of the two coils.

On the other hand, in a state where the armature phase is stroked from this state to, for example, 315°, the central phase of the first coil 511 is about 270°, and the central phase of the second coil 512 is about 360°. Therefore, the magnitude of the interlinkage magnetic flux density in the first coil 511 becomes maximum, and the magnitude of the interlinkage magnetic flux density in the second coil 512 becomes minimum, approximately zero. Therefore, in this state, it is possible to maximize the thrust by full-amount-energizing the first coil 511 and not energizing the second coil 512 to set the energization amount thereof to zero.

In a state where the armature phase is further stroked from this state to, for example, 360°, the central phase of the first coil 511 is about 315°, and the central phase of the second coil 512 is about 405°. In this phase, the interlinkage magnetic flux densities in the coils are equal in magnitude but opposite in sign. Therefore, in actual energization control, in addition to distributing the energization amount between these coils, control of the energization direction (that is, an electric current distribution) is also performed, and these coils are energized in opposite phases.

As a result, the Lorentz forces in the same direction are obtained from the two coils, and the thrust of the armature 510 is maximized. It should be noted that since the illustration and description also including the energization direction are capable of being omitted as long as the description is limited to the effects of the first embodiment, the illustration of such an electric current distribution is omitted, and only a distribution of the absolute value of the power is illustrated.

By such energization control, in the conventional linear motor 500, a thrust profile F510 having the characteristic shown in FIG. 11 is obtained. The thrust profile F510 corresponds to the sum of a thrust profile F511 which is a thrust component due to the first coil 511 and a thrust profile F512 which is a thrust component due to the second coil 512.

As shown in the thrust profile F510, in a multi-pole linear motor, a thrust with a magnitude above a certain value is generally ensured at any continuous stroke position (any continuous phase). However, the value is accompanied by a ripple, which is a so-called thrust ripple resulting from the configuration of the multi-pole linear motor. In this thrust ripple, a maximum value indicates the presence of a phase with high efficiency within a stroke range, and a minimum value indicates the presence of a phase with low efficiency within the stroke range.

Generally, when the efficiency of a linear motor decreases, the maximum output per unit of maximum power decreases, the load driving capability (such as the maximum mass of the corresponding load, and a maximum driving acceleration) decreases, and the power consumption during driving increases, which is undesirable. There are a case where a linear motor is used as, for example, an actuator that is a positioning mechanism, and in particular a case where the positioning mechanism is capable of taking a posture that supports the own weight of an object to be driven. In this case, when a phase with low efficiency exists within the stroke range of the linear motor, even if the efficiency is high in other phases, the mass of the object to be driven that is capable of being positioning-driven and the driving acceleration will decrease in the phase with low efficiency. For this reason, in practical use, the minimum efficiency in the phase with low efficiency becomes a bottleneck. Therefore, it has been a conventional issue to prioritize increasing the minimum value of the thrust ripple of the linear motor.

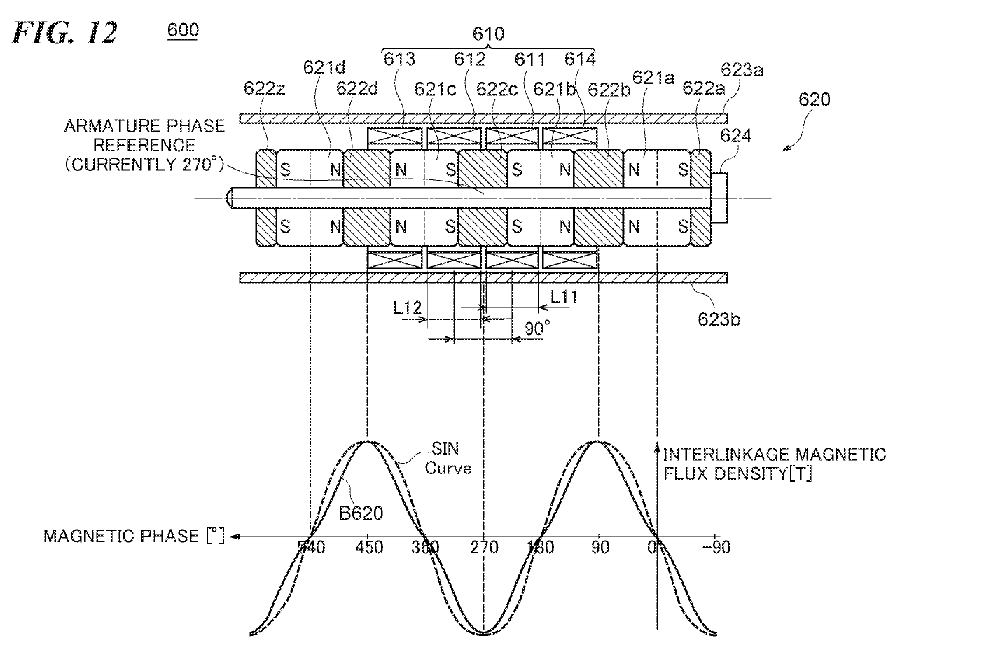

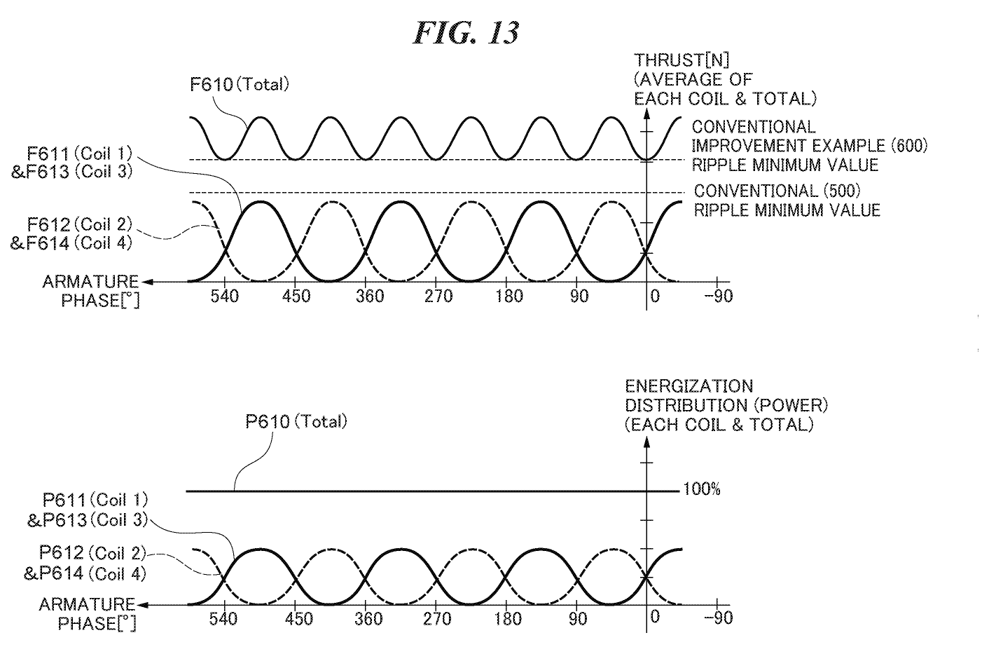

In order to address the above issue, as will be described with reference to FIG. 12 and FIG. 13, conventionally, the improvement has been attempted.

FIG. 12 includes a longitudinal section view of a second comparative example and a diagram that illustrates an interlinkage magnetic flux density profile of the second comparative example. FIG. 13 is a diagram that illustrates a characteristic of a thrust due to energization control in the second comparative example.

A linear motor 600, which is the second comparative example, is an improvement over the first comparative example (the linear motor 500).

As shown in FIG. 12, an armature 610 includes a first coil 611 and a second coil 612 that are similar to the first coil 511 and the second coil 512 of the armature 510. Furthermore, a third coil 613 and a fourth coil 614 are added to the armature 610. The configuration of a field magnet portion 620 is similar to that of the field magnet portion 520. Permanent magnets 621a to 621d, inner yokes 622a to 622dand 622z, outer yokes 623a and 623b, and a skewer 624 correspond to the permanent magnets 521a to 521d, the inner yokes 522a to 522d and 522z, the outer yokes 523a and 523b, and the skewer 524.

An interlinkage magnetic flux density profile B620 (see FIG. 12) corresponds to the interlinkage magnetic flux density profile B520 (see FIG. 10). Thrust profiles F610 to F614, a total value P610, and energization amounts P611 to P614 (see FIG. 13) correspond to the thrust profiles F510 to F512, the total value P510, and the energization amounts P511 and P512 (see FIG. 11).

As shown in FIG. 13, by distributing the energization amounts P611 to P614 to the four coils 611 to 614, the thrust in each coil becomes as shown by the thrust profiles F611 to F614. The total thrust profile F610 is improved, and the thrust minimum value, which is the bottleneck, is higher than that of the linear motor 500 (see FIG. 11).

However, in the linear motor 600, as shown in FIG. 12, the third coil 613 and the fourth coil 614 in the armature 610 are increased, so that the length in a main shaft 600a direction is increased. As a result, compared to the linear motor 500, if the field magnet portion 620 of the same length is used, the strokeable range will be shorter, or if the strokeable range of the same length is to be obtained, the field magnet portion 620 will be longer. This has resulted in another issue of the linear motor 600 becoming larger in external shape.

In addition, as another improvement measure, thrust ripple can be improved by increasing the number of coils from two to three or four in the armature of the linear motor, while keeping the total coil length along the main-shaft axis unchanged, that is, by performing multi-phase control. However, in this case, another issue arises in that hardware resources (for example, driver ICs, various wiring, etc.) and software resources (for example, the memory capacity for control programs) required to individually control the energization of the multi-phase coils become bloated.

The present disclosure has been made primarily in consideration of these conventional issues. In other words, the present disclosure aims to improve the minimum value of the thrust ripple, which can be a bottleneck in practical use in the linear motor, while minimizing the enlargement of the linear motor's external shape and the surrounding drive system. Next, the linear motor 100 according to the first embodiment will be described.

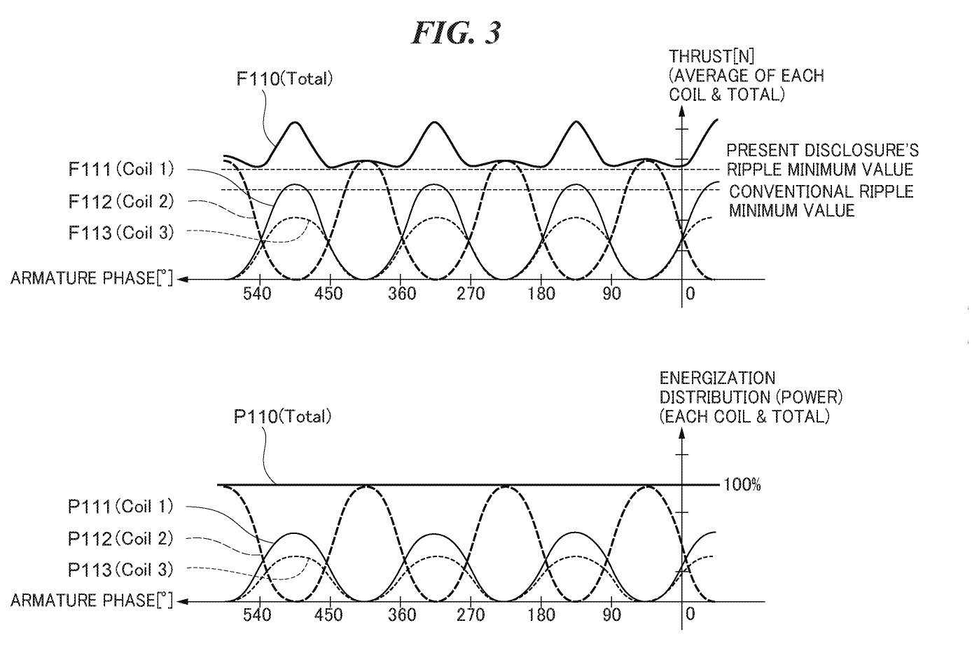

FIG. 2 includes a longitudinal section view of the linear motor 100 and a diagram that illustrates an interlinkage magnetic flux density profile of the linear motor 100. FIG. 3 is a diagram that illustrates a characteristic of a thrust due to energization control in the linear motor 100.

As will be described below, although the linear motor 100 includes the third coil 113 added to the armature 110 compared to the configuration of the linear motor 500 (see FIG. 10), the total length in the main shaft 100a direction of the coils is kept shorter than that of the linear motor 600 (see FIG. 12).

A thrust as a resultant force is obtained by controlling an energization amount ratio between the first coil 111, the second coil 112, and the third coil 113 in accordance with the phase of the armature 110 relative to the field magnet portion 120.

As shown in FIG. 3, the coils 111, 112, and 113 are energized with energization amounts P111, P112, and P113. The total value of the energization amounts P111, P112, and P113 is a total value P110. A thrust due to the coil 111 is indicated by a thrust profile F111, a thrust due to the coil 112 is indicated by a thrust profile F112, and a thrust due to the coil 113 is indicated by a thrust profile F113. The sum of the thrust due to the coil 111, the thrust due to the coil 112, and the thrust due to the coil 113 is indicated by a thrust profile F110. In addition, FIG. 2 shows the interlinkage magnetic flux density profile B120 of the linear motor 100.

The first coil 111 and the second coil 112 are disposed so that a phase distance between each other's centroids in the main shaft 100a direction becomes 90° + n × 180° (n is an integer), corresponding to a periodic change characteristic along the main shaft 100a direction of the interlinkage magnetic flux density caused by the field magnet portion 120. Specifically, a phase distance between centroids of the first coil 111 and the second coil 112 is 90°. Furthermore, the third coil 113 is disposed in accordance with the periodic change characteristic along the main shaft 100a direction of the interlinkage magnetic flux density caused by the field magnet portion 120.

As shown in FIG. 2, the third coil 113 is disposed at a position relative to either the first coil 111 or the second coil 112 such that a phase distance between each other's centroids in the main shaft 100a direction is greater than 135° and smaller than 225°. In the first embodiment, as an example, the third coil 113 is disposed at a phase of 203°, which corresponds to a phase of about 180° in the main shaft 100a direction, relative to the first coil 111. As a result, as shown in FIG. 3, regarding the change in the energization amount in accordance with the armature phase, the third coil 113 is capable of being controlled in phase with the first coil 111 (see the energization amounts P111 and P113). Therefore, it becomes possible to connect the third coil 113 in parallel with the first coil 111 and perform the energization control by the same control signal (the same applied voltage). From this perspective, in the linear motor 100, even if the number of coils is increased, pressure on the hardware resources and the software resources is avoided.

It should be noted that it is desirable that DC resistance values of the third coil 113 and the first coil 111 are adjusted so that the power is input to the third coil 113 at a predetermined percentage of the power input to the first coil 111. For example, as shown by the energization amounts P111, P112, and P113 (see FIG. 3), in order to make the energization amount ratio between the first coil 111 and the third coil 113 approximately 3:2, a ratio of the DC resistance values of the first coil 111 and the third coil 113 may be configured to be approximately 2:3. In general, since the DC resistance value of a coil is capable of being easily designed by selecting a conductor diameter of the enameled wire to be used as a parameter, the DC resistance value of the coil is capable of being easily adjusted.

The lengths in the main shaft 100a direction of the coils 111, 112, and 113 are defined as lengths L11, L12, and L13, respectively. It is preferable that the lengths L11 and L12 are approximately equal to each other. The length L13 of the third coil 113 is equal to or greater than the length L11 of the first coil 111, and is at most shorter than twice the length L11 of the first coil 111 (L11 ≤ L13 < 2 × L11). It is preferable that the length L13 is longer than each of the first coil 111 and the second coil 112.

The third coil 113 is added for the purpose of compensating for the thrust in a phase where the efficiency is insufficient (becomes minimum) when only the first coil 111 and the second coil 112 are used. The reason for adopting the above lengths is that it is more advantageous for the third coil 113 to obtain a stable thrust over a wide phase than to obtain a high thrust over a specific narrow phase. As a result, as shown in FIG. 3, the thrust profile F113 of the third coil 113 exhibits a characteristic in which the half-value width thereof is wider than that of the thrust profile F111 of the first coil 111.

With the configuration described above, the total thrust profile F110 for all coils in the linear motor 100 exhibits a characteristic with an improved minimum value compared to the linear motor 500 of the first comparative example (see FIG. 11). As a result, by adding the minimum required number of coils to the linear motor 500, the bottleneck for the purpose such as positioning is improved while suppressing increasing in size.

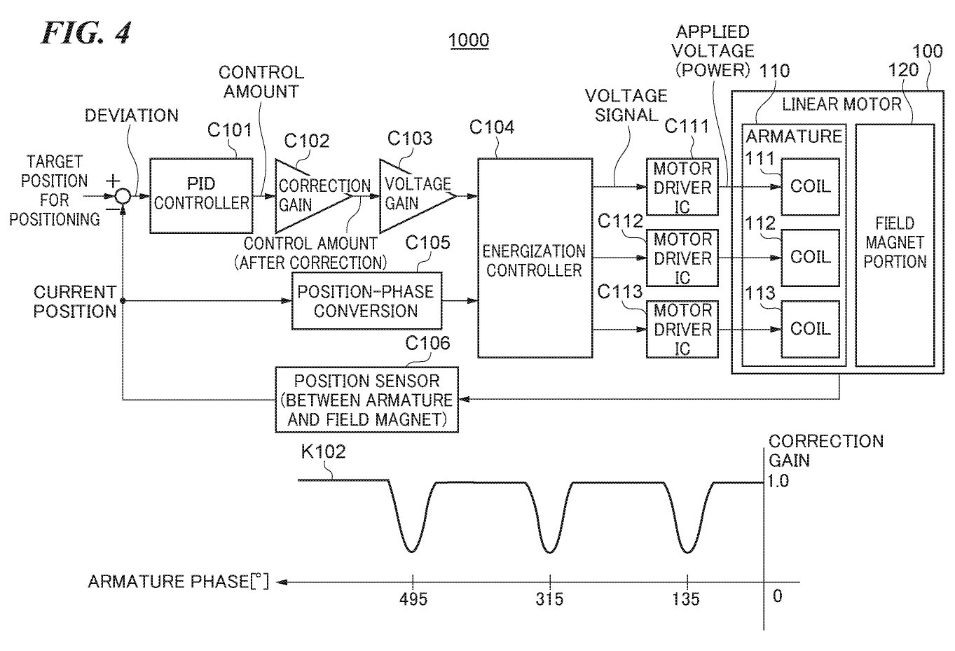

Incidentally, as a more desirable configuration, a correction gain may be applied to the input for outputting a thrust when driving the linear motor 100. This will be described with reference to FIG. 4. It should be noted that it is not essential to apply the correction gain.

In the thrust profile F110 (see FIG. 3) of the linear motor 100, the minimum value of the thrust ripple, which is the bottleneck, is improved. On the other hand, compared to the first comparative example (see FIG. 11), the maximum value is remarkably high at the double period (a frequency of occurring once every two times), resulting in a characteristic that exhibits a thrust ripple due to high frequency noise. As a result, for example, in the purpose of continuously driving the positioning stroke near the phase showing this maximum value, there is a possibility that the controllability will be slightly reduced. Therefore, it is possible to mitigate the influence by applying a correction gain that cancels the increase in the thrust.

FIG. 4 is a diagram that illustrates a block diagram of a linear motor system, which performs position (phase) feedback control using the linear motor 100, together with a profile of a correction gain. Such feedback control is widely used in the purpose of positioning drive using a linear motor.

As shown in FIG. 4, a linear motor system 1000 includes a position sensor C106, and continuously (at a fast period) obtains the current position of the load driven by the linear motor 100. Then, the linear motor system 1000 determines a control amount for a deviation of the current position from a target position for positioning, for example, by a PID controller C101, and causes to output a thrust of the linear motor 100 proportional to the determined control amount. The current position is also input to an energization controller C104 via a position-phase converter C105.

The direct inputs to the linear motor 100 are DC voltages to be applied to the coils, and in order to stably output the DC voltages to be applied to the coils, motor driver ICs C111 to C113 are used. The linear motor system 1000 determines a voltage command value by applying a predetermined voltage gain C103 to the above-described control amount, and inputs the determined voltage command value to each motor driver IC by the energization controller C104. By applying a correction gain C102 between the PID controller C101 and the voltage gain C103, it is possible to correct a thrust to be output.

The correction gain is indicated by a profile K102. Based on a gain of 1.0 which indicates no change due to correction, it is preferable to set the correction gain to a smaller value in the phase around the maximum value of the thrust ripple of the linear motor 100. In other words, the correction gain is set to a gain greater than 0 and equal to or less than 1.0. As a result, the total thrust output level (an open gain) of the linear motor 100 approaches a flat characteristic with less ripple, allowing the linear motor 100 to be used with better controllability.

According to the first embodiment, the third coil 113 is disposed at a position relative to the first coil 111 such that a phase distance between each other's centroids in the main shaft 100a direction is greater than 135° and smaller than 225°, that is, the third coil 113 is disposed at a phase of 203°. As a result, since it is possible to increase the minimum value of the thrust ripple during the stroke, it is possible to improve the bottleneck while suppressing increasing in size and complexity.

In addition, the third coil 113 is connected in parallel with the first coil 111, and the DC resistance value of the third coil 113 is greater than the DC resistance value of the first coil 111, and the first coil 111 and the third coil 113 are controlled in phase with each other. As a result, it is possible to suppress an increase in the hardware resources and the software resources.

In addition, by performing gain control for reducing the thrust at a phase where the maximum value of the thrust occurs, it is possible to suppress a decrease in controllability near the phase showing the maximum value.

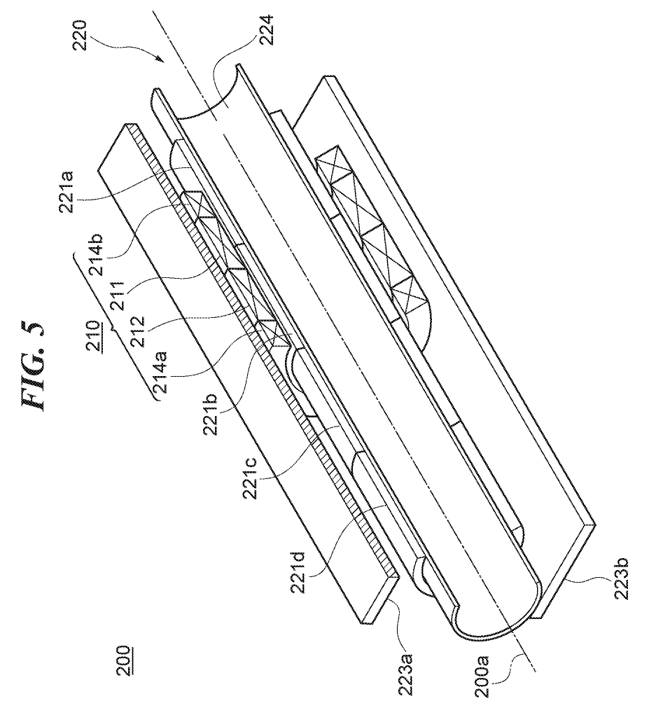

Next, a second embodiment of the present disclosure will be described. FIG. 5 is a schematic perspective view of a linear motor according to the second embodiment of the present disclosure. FIG. 5 illustrates the main part of a linear motor 200. The linear motor 200 is configured by combining an armature 210 and a field magnet portion 220.

In the linear motor 200 shown in FIG. 5, parts (portions) corresponding to those of the linear motor 100 are given reference numerals with the same last two digits, and detailed description of overlapping contents will be omitted.

As shown in FIG. 5, in the linear motor 200, the configuration of the field magnet portion 220 is significantly different from that of the linear motor 100 (see FIG. 1 and FIG. 2). Permanent magnets 221ato 221d are thin-walled ring-shaped. A pipe 224 passes through the permanent magnets 221ato 221d and bundles them together. The pipe 224 has a larger diameter, is hollow, and has a thin-walled shape, in contrast to the skewer 124 (see FIG. 2) of the linear motor 100, which has a small diameter and a solid shape. As a result, the field magnet portion 220 has a hollow shape around a main axis 200a. Such a shape may be useful in various purposes, such as the purpose of passing, for example, wiring, optical fibers, or a shaft through the hollow portion, and the purpose of using the hollow portion as an optical path.

Along with thinning the permanent magnets 221ato 221d (as the permanent magnets 221ato 221d are configured to have a thin-walled shape), a magnetization direction of the permanent magnets 221ato 221d is a direction perpendicular to the main axis 200a. In other words, the permanent magnets 221ato 221d are magnetized in a so-called radial direction connecting the inside and outside of the ring shape. The magnetic pole distribution in the circumferential direction is unipolar, so-called radial unipolar magnetization. As a result, by making an outer peripheral side face with a larger area becoming a magnetic pole face, rather than a thrust face whose area is reduced due to thinning, the configuration enables an effective interlinkage magnetic flux density to be generated in the linear motor 200.

The permanent magnets 221a to 221d are disposed so that magnets with mutually different magnetization directions, which are radial directions, are arranged alternately. Since there is no need to interpose an inner yoke between the permanent magnets, in the linear motor 200, no internal yoke is used between the permanent magnets.

The pipe 224 not only serves to bundle and hold the permanent magnets 221ato 221d, but also serves as a yoke for the inner magnetic pole faces of the radially magnetized permanent magnets 221ato 221d. For this reason, the pipe 224 is made of, for example, a ferromagnetic and high-strength steel material such as structural steel or magnetic stainless steel. The thin-walled pipe 224 is formed by, for example, cutting processing, drawing and extrusion processing, or forming processing in which a thin plate member is rolled into an arc and seams are seamed with electric current as needed.

The armature 210 includes fourth coils 214a and 214b as a third coil in addition to a first coil 211 and a second coil 212.

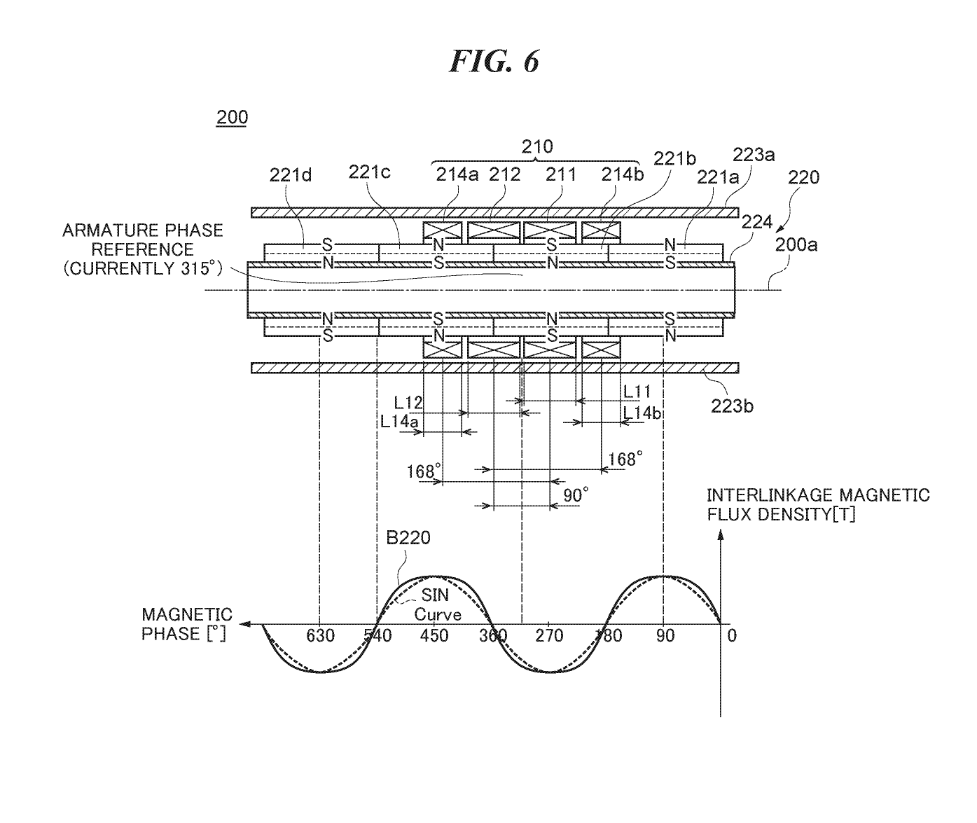

FIG. 6 includes a longitudinal section view of the linear motor 200 and a diagram that illustrates an interlinkage magnetic flux density profile of the linear motor 200. FIG. 6 shows an interlinkage magnetic flux density profile B220 formed by the field magnet portion 220.

Compared with the interlinkage magnetic flux density profile B120 (see FIG. 2) of the linear motor 100, the interlinkage magnetic flux density profile B220 has a flattened and widened waveform with a large half-value width relative to the period. In other words, the interlinkage magnetic flux density profile B120 (see FIG. 2) of the linear motor 100 has a steep waveform with a small half-value width relative to the period. In the field magnet portion 220 exhibiting the interlinkage magnetic flux density profile B220 that has the flattened and widened waveform shown in FIG. 6, it is preferable to dispose the coils 214a and 214b in the armature 210 rather than the coil 113 (see FIG. 2). For this reason, the coils 214a and 214b are added to the armature 210.

Here, as the third coil to be added, whether to select the third coil 113 as in the first embodiment or to select the fourth coils 214a and 214b as in the second embodiment may be determined from the following perspective. For example, it may be determined based on whether the periodic change characteristic along the axial direction of the interlinkage magnetic flux density (the interlinkage magnetic flux density profile) is more triangular wave-like than a sine wave, or more rectangular wave-like than a sine wave.

Specifically, when compared to a sine wave (SIN Curve) in which the level of the maximum value is aligned with respect to the interlinkage magnetic flux density profile, if the half-value width of the interlinkage magnetic flux density profile is narrower than the half-value width of the sine wave (SIN Curve), it may be determined to be more triangular wave-like. On the other hand, if the half-value width of the interlinkage magnetic flux density profile is wider than the half-value width of the sine wave (SIN Curve), it may be determined to be more rectangular wave-like. Furthermore, in the case where the interlinkage magnetic flux density profile is closer to a triangular wave than a sine wave, the third coil 113 (see FIG. 2) may be selected, and in the case where the interlinkage magnetic flux density profile is closer to a rectangular wave than a sine wave, the fourth coils 214a and 214b (see FIG. 6) may be selected.

Here, before describing the effects of the multi-pole linear motor 200 according to the second embodiment, a conventional multi-pole linear motor will be described as a comparative example.

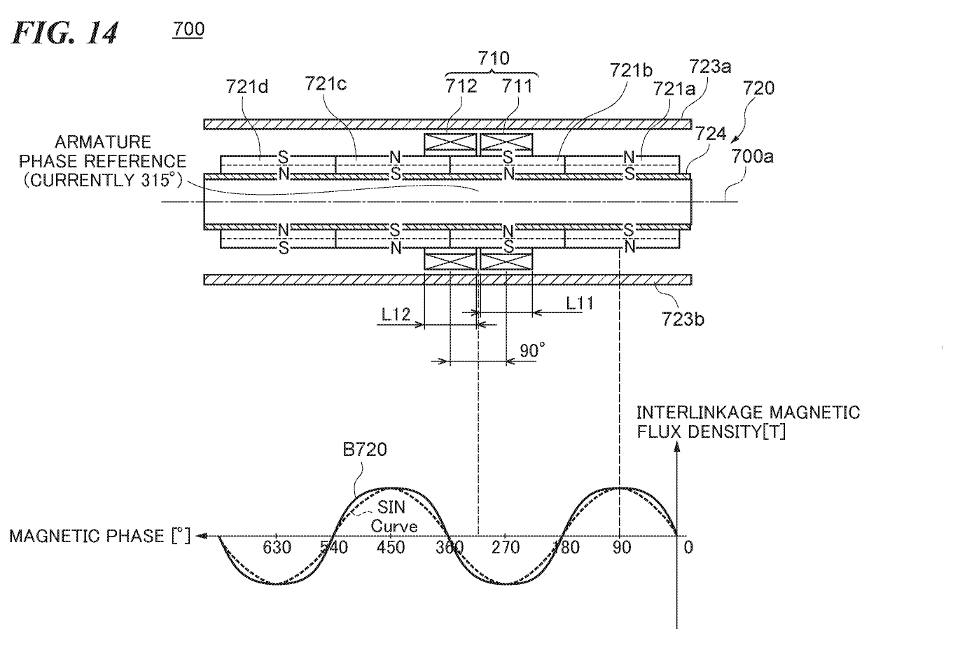

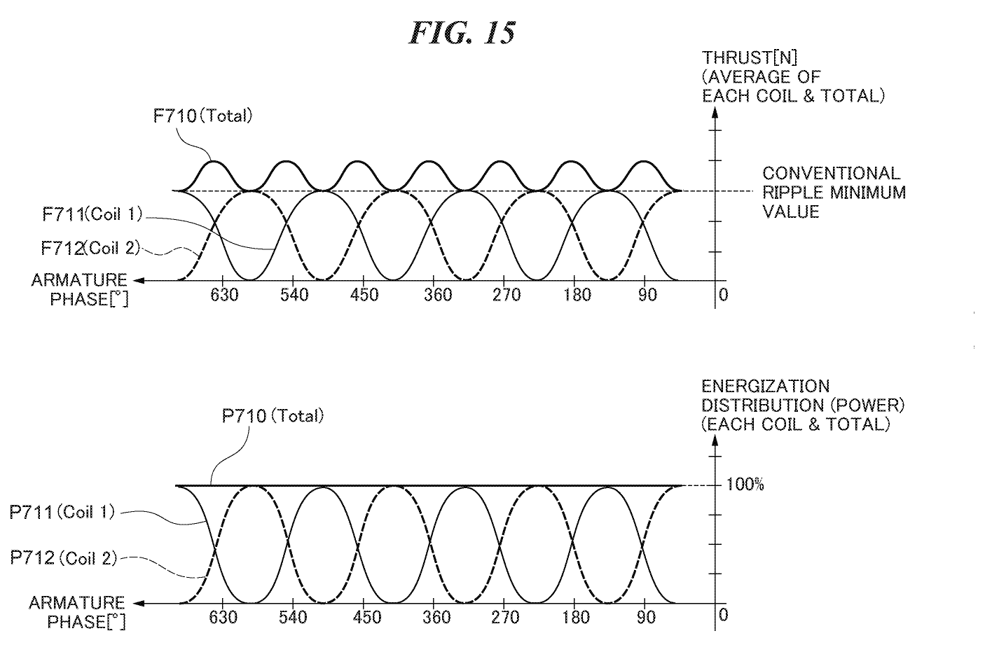

FIG. 14 includes a longitudinal section view of a third comparative example (a conventional multi-pole linear motor 700) and a diagram that illustrates an interlinkage magnetic flux density profile of the third comparative example. FIG. 15 is a diagram that illustrates a characteristic of a thrust due to energization control in the third comparative example.

In the linear motor 700 (see FIG. 14), parts (portions) corresponding to those of the linear motor 200 (see FIG. 5 and FIG. 6) are given reference numerals with the same last two digits.

The linear motor 700 includes a field magnet portion 720 having the same configuration as the linear motor 200, and an armature 710 includes a first coil 711 and a second coil 712. The linear motor 700 corresponds to a configuration in which the fourth coils 214a and 214b are removed from the armature 210 of the linear motor 200.

In addition, the linear motor 700 and the linear motor 500 (see FIG. 10 and FIG. 11) have different characteristics in the interlinkage magnetic flux density profile. The interlinkage magnetic flux density profile B520 of the linear motor 500 is triangular wave-like, whereas an interlinkage magnetic flux density profile B720 of the linear motor 700 is rectangular wave-like.

As shown in FIG. 15, similar to the linear motor 500 (see FIG. 11), a thrust profile of the linear motor 700 exhibits a periodic ripple, that is, a ripple. However, the phases of the maximum value and the minimum value (the magnetic phase and the armature phase that approximately coincides with the magnetic phase) in the linear motor 700 are different from those in the linear motor 500.

In other words, in the linear motor 500, as shown in FIG. 11, the two coils are energized in equal portions, and a thrust becomes minimum at the phases (0°, 90°, 180°, 270°, etc.) where the thrust is obtained from the two coils. On the other hand, in the linear motor 700, as shown in FIG. 15, one of the two coils is full-amount-energized, and a thrust becomes minimum at the phases (45°, 135°, 225°, 315°, etc.) where the thrust is obtained from one coil.

This is, as described above, due to the difference in the characteristic of the interlinkage magnetic flux density profile caused by the field magnet portion. For this reason, the optimum position where the coil should be disposed to compensate for the minimum value of the thrust is different.

In the second embodiment, the interlinkage magnetic flux density profile B220 (see FIG. 6) is closer to a rectangular wave than a sine wave. Therefore, the fourth coils 214a and 214b are disposed as the third coil in the armature 210, corresponding to the first coil 211 and the second coil 212, respectively. Specifically, as shown in FIG. 6, the fourth coil 214a is disposed corresponding to the first coil 211, and the fourth coil 214b is disposed corresponding to the second coil 212.

The fourth coils 214a and 214b are respectively disposed at positions relative to the first coil 211 and the second coil 212 such that a phase distance between each other's centroids in the main axis 200a direction is greater than 135° and smaller than 225° (at about 180° position). Specifically, as an example, the fourth coil 214a is disposed at a phase of about 168° in the main axis 200a direction relative to the first coil 211, and the fourth coil 214b is disposed at a phase of about 168° in the main axis 200a direction relative to the second coil 212.

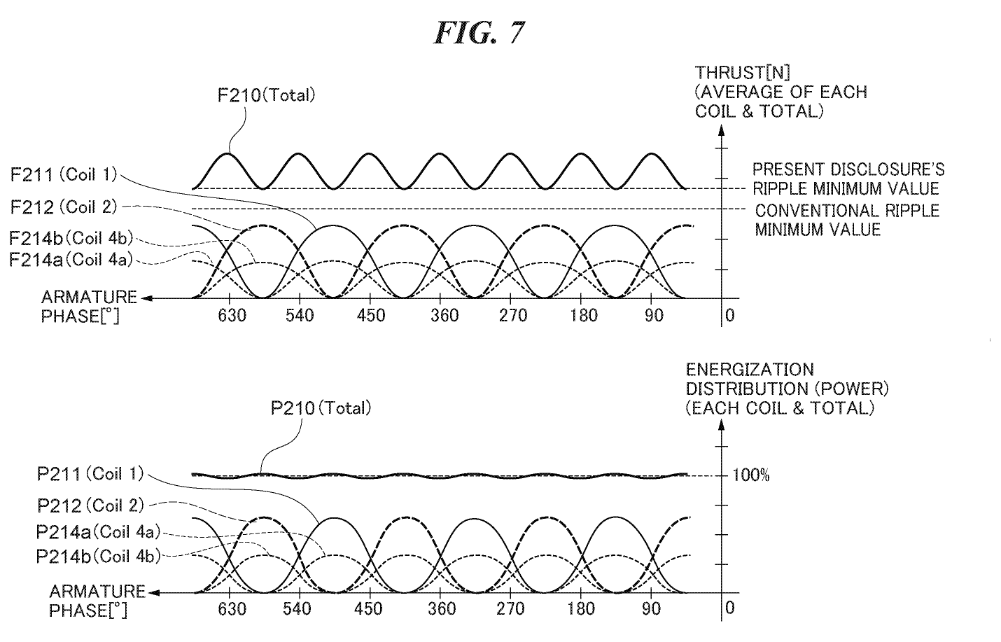

FIG. 7 is a diagram that illustrates a characteristic of a thrust due to energization control in the linear motor 200.

A thrust as a resultant force is obtained by controlling an energization amount ratio between the coils 211 and 212 and the coils 214a and 214b in accordance with the phase of the armature 210 relative to the field magnet portion 220.

In the third comparative example (the linear motor 700), the thrust profile, the total value, and the energization amount are indicated by thrust profiles F710 to F712, a total value P710, and energization amounts P711 and P712 (see FIG. 15). On the other hand, in the linear motor 200 of the second embodiment, the thrust profile, the total value, and the energization amount are indicated by thrust profiles F210 to F212, F214a, and F214b, a total value P210, and energization amounts P211, P212, P214a, and P214b (see FIG. 7).

The lengths in the main axis 200a direction of the coils 214a and 214b are defined as lengths L14a and L14b, respectively. The lengths L14a and L14b of the coils 214a and 214b are both shorter than the lengths L11 and L12 of the coils 211 and 212 (see FIG. 6). By adopting such a configuration, the minimum value of the total thrust profile F210 is increased (see FIG. 7).

In the case where the first coil 211 is full-amount-energized, the thrust becomes minimum at phases of 135°, 315°, 495°, and so on. In the case where the second coil 212 is full-amount-energized, the thrust becomes minimum at phases of 225°, 405°, and 585°. In the second embodiment, as shown in FIG. 7, in addition to the coils 211 and 212, a thrust is capable of being obtained by energizing either one of the fourth coils 214a and 214b (see the energization amounts P214a and P214b, and the thrust profiles F214a and F214b ).

Specifically, the thrust is increased by energizing the fourth coil 214a at a phase where the thrust becomes minimum due to full-amount-energizing the first coil 211. In addition, the thrust is increased by energizing the fourth coil 214b at a phase where the thrust becomes minimum due to full-amount-energizing the second coil 212. Therefore, it is possible to improve the minimum value of the thrust profile F210.

Since the fourth coils 214a and 214b only need to obtain a thrust that improves the minimum value of the total thrust, the fourth coils 214a and 214b do not need to be as long as the first coil 211 and the second coil 212 in the main axis 200a direction, and are capable of being disposed shorter. Therefore, since an increase in the total length in the main axis 200a direction is capable of being kept smaller than that of the linear motor 600 (see FIG. 12), the linear motor 200 is also capable of being prevented from becoming larger.

Here, in the fourth coils 214a and 214b of the linear motor 200, similar to the case of the third coil 113 of the linear motor 100 (see FIG. 2), approximately the same phase is capable of being applied to the corresponding coils 211 and 212, as the phase of the energization distribution. For example, as shown in FIG. 7, it is possible to apply the energization amounts P211, P212, P214a and P214b.

Therefore, the fourth coil 214a is capable of being connected in parallel with the first coil 211, and the fourth coil 214b is capable of being connected in parallel with the second coil 212, and they are capable of being driven and controlled by the same motor driver IC and the same control signal. As a result, it is possible to save the hardware resources and the software resources.

In addition, in order to adjust the energization amount ratio between the coils connected in parallel, as in the first embodiment, a ratio of the DC resistance values of the coils connected in parallel may be adjusted. The DC resistance values of the fourth coils 214a and 214b are greater than the DC resistance values of the corresponding coils 211 and 212. For example, as shown by the energization amounts P211, P212, P214a, and P214b (see FIG. 7), the energization amount ratio between the first coil 211 and the fourth coil 214a, and the energization amount ratio between the second coil 212 and the fourth coil 214b are each set to approximately 2:1. Furthermore, the respective coils may be configured so that the ratio of the DC resistance values of the first coil 211 and the fourth coil 214a, and the ratio of the DC resistance values of the second coil 212 and the fourth coil 214b are each approximately 1:2.

In addition, in the linear motor 200, similar to the linear motor 100 (see FIG. 2), the correction gain (see FIG. 4) may be applied to the control amount that is the input when performing drive control, thereby performing the drive control so that the output characteristic approaches flat. As a result, it is possible to suppress a decrease in controllability near the phase showing the maximum value.

According to the second embodiment, it is possible to achieve the same effects as the first embodiment in terms of increasing the minimum value of the thrust ripple during the stroke and in terms of improving the bottleneck while suppressing increasing in size and complexity.

It should be noted that in the case where the gain control is applied in the second embodiment, the thrust decreases at the phase where the maximum value occurs. It should be noted that gain correction control may be performed so as to lower the overall output level at a phase in which one coil of the coils 214a and 214b, with which the coils 211 and 212 are connected in parallel, is energized at a percentage greater than that of the other coil of the coils 214a and 214b.

Next, a third embodiment of the present disclosure will be described. In the third embodiment of the present disclosure, an example in which the linear motor(s) described in the first embodiment and the second embodiment to an optical apparatus will be described.

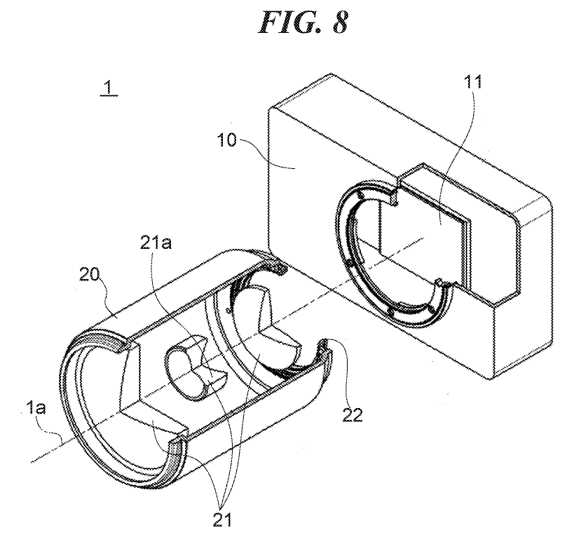

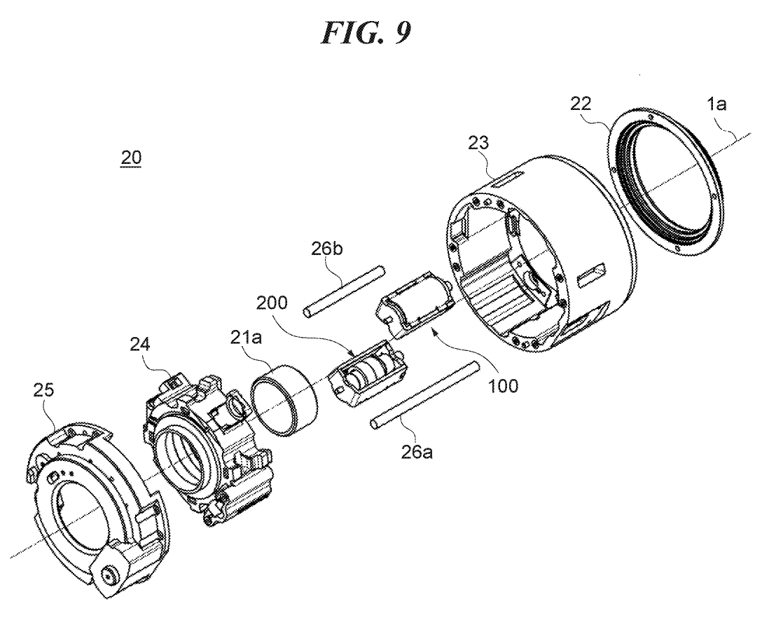

FIG. 8 is a perspective view of a camera system to which the linear motor is applied. FIG. 9 is an exploded perspective view of an optical apparatus in the camera system. As shown in FIG. 8, a camera system 1 is a digital camera system that is configured by a combination of a camera main body 10 and an interchangeable lens 20 (a lens barrel).

The linear motor 100 and the linear motor 200 are mounted on the interchangeable lens 20 as an optical apparatus in the camera system 1. It should be noted that the linear motor to be applied to the optical apparatus may be either the linear motor 100 or the linear motor 200, or may be both of the linear motor 100 and the linear motor 200. In addition, the number of linear motors to be mounted does not matter, and a plurality of the same linear motors may be mounted.

In the camera system 1, a group of lenses 21 (only a portion of which is shown in FIG. 8) within the interchangeable lens 20 focuses a subject light beam onto a solid-state image pickup device (a solid-state image sensor) 11 within the camera main body 10 to form an image, and image signals are obtained by the solid-state image pickup device 11 performing a photoelectric conversion, etc. The image signals are subjected to various kinds of data processing and then saved as image data, thereby performing photographing of a photo (a still image) or a video (a moving image).

In the interchangeable lens 20, in order to bring a subject at an arbitrary distance into focus, a so-called focusing function of moving and positioning a focusing lens 21a, which is an optical device, in the direction of an optical axis 1a (an optical axis 1a direction) is important. In addition, in order to adjust a photographing view angle in a zooming lens, a so-called zooming function of moving and positioning a zooming lens group (not shown) in the optical axis 1a direction is important.

For these positionings, a quiet operation is required in addition to a high speed and high precision operation and a constant speed feeding operation, so the linear motor is widely used as an actuator. Since it is preferable that the interchangeable lens 20 is as small and light as possible, it is desirable that the linear motor also is made smaller and lighter. In addition, since it is preferable for the camera system 1 to be able to perform photographing for as long as possible while keeping the power consumption low, it is desirable for the linear motor to also keep the power consumption low, that is, to increase the efficiency of the thrust.

The positioning operations for focusing and zooming in the interchangeable lens 20 need to be able to operate stably both statically and dynamically at any continuous position within a lens movement range. In other words, as the characteristic required of a linear motor, it is more important to improve the minimum value of the thrust, which is the bottleneck, as much as possible, than to increase the average efficiency of the entire stroke.

Since the linear motor 100 and the linear motor 200 minimize the increase in their external shapes (their external dimensions) while improving the minimum value of the thrust during the stroke, the linear motor 100 and the linear motor 200 are suitable as actuators for focusing and zooming in such an interchangeable lens 20.

As shown in FIG. 9, the interchangeable lens 20 has a configuration in which a lens holder 24 holding the focusing lens 21a to be driven is disposed inside a fixed barrel 23, and is capable of being moved in the optical axis 1a direction by a linear guide configured by a pair of guide bars 26a and 26b.

In the linear motor 100 and the linear motor 200, the field magnet portion is fixed to one of the fixed barrel 23 and the lens holder 24, and the armature is fixed to the other of the fixed barrel 23 and the lens holder 24. This allows the linear motor 100 or the linear motor 200 to drive the focusing lens 21a in the optical axis 1a direction (an optical axis direction).

The interchangeable lens 20 also includes a mount member 22, a cover member 25 for the fixed barrel 23, etc., but these are not essential parts of the present disclosure and therefore will not be described here.

According to the third embodiment, in an optical apparatus, it is possible to improve the bottleneck while suppressing increasing in size and complexity.

It should be noted that the optical apparatus, to which the linear motors of the first embodiment and the second embodiment are applied, is not limited to a lens barrel, but may be an image pickup apparatus with an integrated lens. Alternatively, the linear motors of the first embodiment and the second embodiment may be mounted on an apparatus other than the optical apparatus.

It should be noted that in the first embodiment, two or more third coils 113 may be provided. In the second embodiment, two or more fourth coils 214a and two or more fourth coils 214b may be provided.

According to the present disclosure, it is possible to improve the bottleneck while suppressing increasing in size and complexity.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-025119, filed February 19, 2025, which is hereby incorporated by reference herein in its entirety.

What is claimed is:

1. A linear motor comprising:
an armature configured to include coils; and
a field magnet portion configured to include permanent magnets and yokes, the field magnet portion moving in an axial direction relative to the armature, and
wherein in the field magnet portion, the permanent magnets and the yokes are disposed so that an interlinkage magnetic flux density, which is a density of interlinkage magnetic flux acting on the armature, changes periodically along the axial direction,
the armature includes a first coil and a second coil, and the first coil and the second coil are disposed so that a phase distance between each other's centroids in the axial direction becomes 90° + n × 180° (n is an integer), corresponding to a periodic change characteristic along the axial direction of the interlinkage magnetic flux density caused by the field magnet portion,
at least one third coil is further disposed on the armature in accordance with the periodic change characteristic along the axial direction of the interlinkage magnetic flux density caused by the field magnet portion,
a thrust as a resultant force is obtained by controlling an energization amount ratio between the first coil, the second coil, and the third coil in accordance with a phase of the armature relative to the field magnet portion, and
the third coil is disposed at a position relative to either the first coil or the second coil such that a phase distance between each other's centroids in the axial direction is greater than 135° and smaller than 225°.

2. The linear motor according to claim 1, wherein
the periodic change characteristic along the axial direction of the interlinkage magnetic flux density is closer to a triangular wave than a sine wave, and
the third coil corresponding to either the first coil or the second coil is disposed on the armature.

3. The linear motor according to claim 2, wherein
in the axial direction, the third coil is longer than both the first coil and the second coil.

4. The linear motor according to claim 2, wherein
the third coil is connected in parallel with either one coil of the first coil or the second coil, and a DC resistance value of the third coil is greater than a DC resistance value of the either one coil.

5. The linear motor according to claim 4, wherein
the either one coil and the third coil are controlled in phase with each other.

6. The linear motor according to claim 2, wherein
a magnetization direction of the permanent magnets is parallel to the axial direction.

7. The linear motor according to claim 1, wherein
the periodic change characteristic along the axial direction of the interlinkage magnetic flux density is closer to a rectangular wave than a sine wave, and
the third coil corresponding to each of the first coil and the second coil is disposed on the armature.

8. The linear motor according to claim 7, wherein
in the axial direction, each of the third coils is shorter than both the first coil and the second coil.

9. The linear motor according to claim 7, wherein
each of the third coils is connected in parallel with one corresponding coil out of the first coil and the second coil, and a DC resistance value of the third coil is greater than a DC resistance value of the one corresponding coil.

10. The linear motor according to claim 9, wherein
the third coil and the one corresponding coil are controlled in phase with each other.

11. The linear motor according to claim 7, wherein
a magnetization direction of the permanent magnets is a direction perpendicular to the axial direction.

12. The linear motor according to claim 1, wherein
the first coil and the second coil are approximately equal in a length in the axial direction.

13. A linear motor system comprising:
the linear motor according to claim 1, and
wherein in the linear motor, gain control for reducing the thrust at a phase where a maximum value of the thrust occurs is performed.

14. An optical apparatus comprising:
the linear motor according to claim 1; and
an optical device configured to be driven by the linear motor and be positioned in an optical axis direction.
